(19) United States
(12) Patent Application Publication
(10) Pub. No.: US 2014/0278046 A1
(43) Pub. Date: Sep. 18, 2014

(54) Fire Hydrant Locator for EMT Personnel

(71) Applicant: Eric Saylors, Newcastle, CA (US)

(72) Inventor: Eric Saylors, Newcastle, CA (US)

(73) Assignee: MOBIUS EXCHANGE, INC., Bend, OR (US)

(21) Appl. No.: 14/205,043

(22) Filed: Mar. 11, 2014

Related U.S. Application Data
(60) Provisional application No. 61/778,005, filed on Mar. 12, 2013.

(51) Int. Cl. H04W 4/22; H04W 64/00; G06F 17/30; H04W 4/02

(52) U.S. Cl. CPC H04W 4/22; H04W 4/023; H04W 64/00; G06F 17/30241
USPC 701/300; 707/736

(57) ABSTRACT

A communication system for first responders includes a plurality of mobile communication devices (MCDs) in communication with a global positioning system (GPS) and a cloud database via a wireless link. Software resident in the MCDs provides an application in which first responders can view and input data showing types and locations of emergency incidents, the units assigned, assigned radio channels, the incident status, graphical location, the location of each unit and other data. A sub-program resident on the MCDs permits users to locate and tag fire hydrants and input their locations and water delivery data into the cloud database.

### CROSS-REFERENCE TO RELATED APPLICATIONS

This application claims priority based upon provisional application Ser. No. 61/778,005 filed Mar. 12, 2013.

### BACKGROUND OF THE INVENTION

Emergency first responders such as fire fighters and EMT personnel face not only life and property threatening situations, but also chaotic conditions on the ground wherever active emergency incidents occur. A major problem is communication. Fire, smoke, noise, and the presence of civilians make it difficult for supervisors and dispatchers to coordinate and command field units. The specific types of units must be matched up with the type of emergency incident so that appropriate resources for the tasks required are properly directed to the right locations and in the right strength to deal with the emergency. Once on location at the incident, communication is vital for command functions.

Knowledge of the status of an incident is vital to commanders in the field and dispatchers so that resources can be directed to the incident that are appropriate for its type and severity. The same knowledge permits directing units to the next emergency incident once a present incident has been cleared. Knowing the location of units and their types as well as the status of incidents to which they have been assigned allows coordination of valuable resources and subsequent assignments to be more efficient.

In the past, units, whether they be individuals or vehicles transporting a plurality of first responders, communicated by radio. In such cases it is vital that all personnel assigned to an incident know which among several radio channels is the radio link for that incident and assigned resources so that local communication is possible. Radio channels must be set before first responders such as firemen attempt to deal with an emergency because in the chaos of fire, noise and smoke searching for appropriate communications channels on the fly will be nearly impossible.

In addition, for incidents involving fire, it is vital for first responders to know where fire hydrants are located in relation to the location of the emergency incident and to know the water delivery parameters of those fire hydrants such as pressure and flow rate. Unfortunately little data presently exists in a form useful to first responders that provides location and/or water delivery data of fire hydrants.

### SUMMARY OF THE INVENTION

A communication system for first responders includes a plurality of mobile communication devices (MCD's) in communication with a global positioning system (GPS) and a cloud database via a wireless link. Software resident in the MCD's provides an application in which first responders can view and input data showing types and locations of emergency incidents, the units assigned, assigned radio channels, the incident status, graphical location, the location of each unit and other data. A sub-program resident on the MCD's permits users to locate and tag fire hydrants and input their locations and water delivery data into the cloud database.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a block schematic diagram of the communication system of the invention.

FIG. 2 is a block diagram illustrating the operation of a web based command and control software program for managing the content of a database used in the system of FIG. 1.

FIGS. 3A-3C represent a flow chart diagram illustrating the operation of the system of FIG. 1.

FIG. 4 is a flow chart diagram of a sub-program for tagging fire hydrants.

FIG. 5 is a schematic representation of the method used by the sub-program of FIG. 4.

FIG. 6 is a detailed rendering of the display screen of screen 30 of FIG. 3A.

FIG. 7 is a detailed rendering of the display screen of screen 32 of FIG. 3A.

FIG. 8 is a detailed rendering of the display screen of screen 34 of FIG. 3A.

FIG. 9 is a detailed rendering of the display screen of screen 42 of FIG. 3A.

FIG. 10 is a detailed rendering of the display screen of screen 38 of FIG. 3A.

FIG. 11 is a detailed rendering of the display screen of screen 42a of FIG. 3B.

FIG. 12 is a detailed rendering of the display screen of screen 44 of FIG. 3B.

FIG. 13 is a detailed rendering of the display screen of screen 46 of FIG. 3B.

FIG. 14 is a detailed rendering of the display screen of screen 48 of FIG. 3B.

FIG. 15 is a detailed rendering of the display screen of screen 50 of FIG. 3B.

FIG. 16 is a detailed rendering of the display screen of screen 46a of FIG. 3C.

FIG. 17 is a detailed rendering of the display screen of screen 54 of FIG. 3C.

FIG. 18 is a detailed rendering of the display screen of screen 58 of FIG. 3C.

FIG. 19 is a detailed rendering of the display screen of screen 60 of FIG. 3C.

FIG. 20 is a detailed rendering of the display screen of screen 64 of FIG. 3C.

FIG. 21 is a detailed rendering of the display screen of screen 68 of FIG. 3C.

FIG. 22 is a detailed rendering of the display screen of screen 72 of FIG. 3C.

FIG. 23 is a detailed rendering of the display screen of screen 76 of FIG. 3C.

FIG. 24 is a detailed rendering of the display screen of screen 80 of FIG. 4.

FIG. 25 is a detailed rendering of the display screen of screen 82 of FIG. 4.

FIG. 26 is a detailed rendering of the display screen of screen 80 of FIG. 4.

FIG. 27 is a detailed rendering of the display screen of screen 94 of FIG. 4.

FIG. 28 is a detailed rendering of the display screen of screen 86 of FIG. 4.

FIG. 29 is a detailed rendering of the display screen of screen 92 of FIG. 4.

FIG. 30 is a detailed rendering of the display screen of screen 82a of FIG. 4.

### DETAILED DESCRIPTION OF PREFERRED EMBODIMENTS

An object of the invention is to facilitate communication within an organization of first responders in a way that makes task assignment and management efficient and understandable, and which provides valuable data to personnel on the ground, often in chaotic situations. Using the system, data can be perceived and communicated despite the presence of noise, smoke, heat and other factors which typically impair or interfere with effective communication.

Mobile communication devices (MCD's) in the form of cell phones and tablet devices are now common and provide a means for establishing a network to perform a variety of communication tasks. In addition, global positioning systems (GPS) which are in communication with such devices, can locate the devices in terms of their latitude and longitude. Software resident in many “smartphones” and electronic tablets automatically tracks the locations of such devices by transmitting a signal to global positioning systems and receives from the GPS a physical location that appears on a display map as a marker at the user's location. This is usually done by means of cellular communication, but can also be accomplished via a Wi-Fi Internet connection.

A display screen in cell phones and tablets is available to render both maps of an area and markers or icons representing particular locations such as addresses and the location of the user. In addition most smartphones and tablets have data entry means in the form of keyboards consisting of mechanical keys or a virtual keyboard rendered on a touch screen.

A communication system for first responders makes use of the inherent capabilities of MCD's coupled with global positioning systems and a database which may reside in the “cloud”. “Cloud” databases are data storage facilities that exist in cyberspace and are accessed by wireless communication like cell phone communication or hard-wired communication over the Internet. The system includes such a database in wireless communication with a plurality of mobile users with MCD's including at least a commander and a field unit. As a practical matter, there are likely to be multiple field units and multiple commanders. The database may be stored in the “cloud” as part of a cloud computing system. Such systems are well known and many variations are possible for the database, including ones in which the database is resident on a local server accessible by the mobile units and the commander. It is to be understood that the terms “users”, “mobile units,” and “field units” are interchangeable and that the “commander” may be a mobile unit. As examples, the commander may be the fire chief or a crew chief and the field units may be a hook and ladder vehicle, an ambulance or an EMT unit. Field units may also be individuals.

The cloud database stores information particular to the needs of first responders including organization data identifying organizations belonging to the network; unit data identifying units belonging to an organization within the network; active incidents to be serviced by the network, each active incident containing data identifying the location of the incident and its type; assignment data indicating identity of mobile units assigned to each active incident; and fire hydrant data comprising fire hydrant locations and water delivery parameters such as pressure and flow rate.

Each mobile unit's MCD contains resident software for performing several functions. This software may be in the form of a downloadable application or “app” which may be obtained from a commercial server and installed on the MCD. If the mobile users are individuals who have iPhones® available from Apple, the software may be downloaded as an iPhone® app. The same holds true for tablet devices, whether iOS based or Android based.

The application allows the mobile users who comprise at least one commander and at least one field unit to communicate over a cellular link or Wi-Fi by way of the cloud database and a GPS. Data entered into the system by any user is transmitted automatically to update the database so that all users can see the data in real time. This feature is invaluable to users on the ground that for one reason or another may not be able to talk to each other by other means.

In addition, dispatch capability may be added by placing a stationary unit or dispatcher in communication with the cloud database via an Internet connection using a conventional web browser. The web based program is downloaded and installed over an Internet connection which may then access the cloud database.

Referring to FIG. 1, a cloud database 10 is in communication with a plurality of mobile units, at least one of which is a commander 12, and several field units 14a, 14b, and 14c. Unit 14c represents the nth unit where n can be any number. Each unit has a mobile communication device (MCD). The designation of a unit as commander is largely arbitrary since under certain conditions any of the field units may assume the functions of the commander. The database is described herein as a “cloud” database 10, but could be a local server, associated, for example, with the dispatch 20. In such a case, the dispatcher 20 would require a computer system capable of communication via cellular signal to the mobile units. Generally, a cloud based system is preferred since such systems are in place and commercially available.

The cloud database 10 is constructed to provide data to the mobile units in response to the application resident on the commander and field unit devices. In addition the database may be updated by the mobile units 12, 14a-c, and/or the dispatcher 20. The database 10 has stored within it data comprising organizations, unit identities and functions, incidents, e.g., fires or injured persons, incident and unit locations, assignments, radio channel assignments, patient data, and fire hydrant data as will be described herein. The database 10 may include other data as may be added from time to time to provide additional functionality to the system.

Referring to the flow chart of FIG. 2, a web based application may provide either a commander 12 with Wi-Fi connectivity or a stationary dispatcher 20 with the ability to control settings on the MCD's of the field units. For example, this application allows the dispatcher 20 to make assignments, give names to assignments, and control how the field units view data on an MCD. Thus at block 22 the dispatcher selects the organization, for example a city or county fire department. Next at block 24, fields may be set for that organization's MCD's including passwords and command modes. The command modes which are edited at block 26 are indicative of the type of incident to which a field unit might be assigned such as “fire” or “hazmat”. Next, the dispatcher/commander at block 28 may assign radio channels for each mode thus created. All of this information is then viewable by the field units 14a-c.

FIGS. 3A-3D illustrate what the field units 14a-c are able to view on their MCD's and provide fields for the entry of data. After login at screen 30, a mobile user selects his organization at screen 32. At screen 34, he selects his assigned unit from a menu of choices. Touching the location button 36 on the select location screen 38 launches a sub program called “hydrants,” to be explained in more depth below. Touching the incidents button 40 launches the active incidents screen 42. This screen shows a list of incidents and their locations on a map as well as the location of the user.

The active incident screens 42, 42a shows all currently active incidents because this information is stored in real time in the cloud database 10. Touching an incident bar on the screen 42 launches a map screen 44 whose resolution may be controlled by a zoom control 41, a feature common on smartphones and tablets. The screen 42 displays the incident to which a field user is assigned and by selecting the assigned incident bar 43, which may be color highlighted, an assigned incident screen 46 is launched. This screen provides both available data retrieved from the cloud database 10 such as location, incident type, and status, but also provides an opportunity to update data through “assigned units” and “patients” fields. Data entered in these fields is transmitted in real time to the database 10 so that all other units may view information that has just been entered. In this way important conditions on the ground are immediately made known to other members of the team. In like manner, touching a non-color highlighted incident (others 45) on screen 42a launches a similar screen 48 which shows the same information for incidents assigned to others. Screens 42, 42a also permits a field unit or commander to add or create incidents at screen 50 by touching the add incident button 47. For example, an incident coded as a “fire” might have casualties which may call for different types of units. Screen 50 allows a commander or field unit to add this information which is then made available immediately through the database 10.

Launching the assigned incident screen 46, 46a provides a field unit with a number of features (refer to FIG. 3C). An “add mode” button 52 launches a screen 54 that permits a user to select a type of incident from a menu which will be added to the assigned incident, for example casualties discovered at a fire. This will allow for a change in status, assigned radio channels, unit assignments, and other organizational protocols as established previously by the dispatcher 20. An edit button 56 can be used to change the dispatch information on screen 58 which it launches, for example the address. An enlargement button 57 may enlarge the map screen 60 that shows various data including the incident location, the user's location, and locations of fire hydrants. Pressing the add unit button 62 launches a drop down menu at screen 64 that allows the commander 12 to add units to a particular call or incident as needed.

A unit button on screen 46a allows the commander 12 to change unit controls on screen 68, which may include for example, a status indicator, e.g., “on route,” “on location” or “cleared.” In addition, radio channel assignments, group, branch, or division identities may be viewed or changed. A delete button 70 launches a screen 72 whereby a unit may be deleted from a call. A patients button 74 launches a screen 76 of patient information controls which provides patient data for EMT personnel. Patient data may be in the form of data described in copending application Ser. No. 13/796,075 entitled Communication System for Emergency Response Team which is assigned to the same assignee and which is incorporated herein by reference.

First responders or others who have MCD's have the ability to populate a cloud or other type of database 10 with data relating to fire hydrants so that when incidents do occur, mobile units such as the commander 12 and field units 14a-c subsequently on the scene may access this data. Accordingly, personnel within a fire district may be assigned the task of canvassing the district and locating all of the fire hydrants in order to build a comprehensive data set which can be stored in the cloud database 10 for subsequent use.

According to a method of the invention, shown best in FIGS. 4 and 5, a user 100 with an MCD 102 first determines a real physical location of a fire hydrant 104. The user launches a “hydrants” program at screen 80 from the select location screen 38, and then places himself in close proximity to the fire hydrant 104. With the MCD 102 the user 100 acquires a location determined by latitude and longitude of his MCD from the GPS 16. Close proximity in this instance means approximately within the resolution capability of the GPS, which may be, for example, a distance of about ten feet. The MCD 102 includes a touch screen or other data entry means on screens 82, 82a for the user to then “tag” the location of the fire hydrant by first using the tag location screen 82. This launches screen 94 when the “get my location” button 83 is pressed. The GPS 16 is queried and it sends location information which populates the add location screen 94. A “tag” button on that screen adds the hydrant location to the database 10 by transmitting the tagged fire hydrant location hydrant to the database 10. In addition other data may be included in the tag such as water delivery data indicative of water pressure and/or flow rate, a photograph of the hydrant and its surroundings and notes that may be useful to first responders such as recognizable landmarks, obstacles or particular parking problems for fire trucks and the like. The location of the user may then be displayed by touching the tagged locations button 84 which brings up on screen 86 a list and a map of hydrant locations. By touching a picture on line 88 or touching a hydrant symbol on the map 90, an edit location screen 92 appears that contains fields for entry of water delivery data. An add location button brings up screen 82a which allows the process to be repeated for the next fire hydrant found or for entry of additional data for the current fire hydrant.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

What is claimed is:

1. A communication system for a network of first responders comprising:
(a) a cloud database containing
(i) organization data identifying organizations belonging to the network;
(ii) unit data identifying units belonging to an organization within the network;
(iii) active incidents to be serviced by the network, each active incident containing data identifying the location of the incident and its type;
(iv) assignment data indicating identity of units assigned to each active incident;
(v) fire hydrant data comprising fire hydrant locations and water delivery parameters;
(b) a GPS satellite system in communication with said cloud database;
(c) a plurality of mobile communication devices(MCD's) in wireless communication with said cloud database and said GPS satellite system, said plurality of MCD's including at least one commander unit and at least one field unit, wherein each of said MCD's include a display screen and a keyboard;
(d) a software program installed in each of said MCD's for
(i) identifying the unit and its location;
(ii) identifying and displaying an active incident to which the unit is assigned, its type, its status and its location; and,
(iii) identifying and displaying the location of the hydrant closest to the active incident and its water delivery parameters.

2. The communication system of claim 1 further including a dispatcher in communication with said cloud database over an Internet connection, said dispatcher providing data to said database for use by said plurality of MCD's.

3. The communication system of claim 1 wherein element (d) further includes a software program for tagging a fire hydrant by entering a location based upon the GPS location of an MCD in proximity to said fire hydrant, wherein a tagged fire hydrant is added to said cloud database by one of said MCD's.

4. The communication system of claim 3 wherein software program includes a data entry field for said MCD to add water delivery data to said tagged fire hydrant.

5. The communication system of claim 4 wherein said software program further includes a data entry field for said field unit to add a photograph to said tagged fire hydrant.

6. The communications system of claim 1 wherein element (d) (ii) further includes a map rendered on a visual display screen and a first marker indicating a location of an active incident.

7. The communication system of claim 6 wherein said map further includes a second marker indicating a location of an MCD accessing said active incident.

8. The communication system of claim 7 further including a display screen for having data entry fields for adding active incidents.

9. The communication system of claim 6 wherein said display screen rendering includes visual markers indicating the locations of fire hydrants proximate said location of said active incident.

10. The communication system of claim 2 wherein said data provided by said dispatcher includes radio channels assigned to selected field units.

11. A communication system for first responders comprising
(a) a cloud database, said database including a list of emergency incidents, their type and their geographic locations, and a list of fire hydrants within a selected area including the locations and water delivery parameters associated with each of said fire hydrants;
(b) a plurality of mobile users in wireless communication with said database, said mobile users each having receiver/transmitter means for establishing communication with a global positioning system for receiving data related to the emergency incidents including their locations, type and status, each of said mobile users having data entry means for entering selected data to be transmitted to said cloud database, said data including the status of emergency incidents and the location and water delivery parameters of fire hydrants;
(c) each of said mobile users having display means for displaying a map of a selected area in which emergency incidents are occurring and an overlay of markers on said map representing the locations of said emergency incidents, fire hydrants within said selected area and present locations of said mobile users.

12. The communication system of claim 11 wherein at least one of said mobile users is a command mobile user, said command mobile user having means for assigning other select mobile users to active emergency incidents at select geographic locations.

13. The communication system of claim 12 further including a dispatch unit coupled to said cloud database for causing data related to select emergency incidents to be delivered to select ones of said mobile users.

14. The communication system of claim 12 wherein said cloud database includes radio channel data and said command mobile user includes means for assigning selected radio channels to select mobile users.

15. A method of populating a database with fire hydrant data to be accessed by emergency first responders, wherein the first responders have mobile communication devices (MCD's) in communication with a cloud database and with a GPS, and wherein the MCD's have display screens and data entry means for inputting data, the steps comprising:
(a) providing a user with an MCD;
(b) said user determining a physical location of a fire hydrant and moving to said physical location in close proximity to said fire hydrant;
(c) acquiring a location signal on said MCD from said GPS indicative of a point in close proximity to said fire hydrant;
(d) tagging said fire hydrant by transmitting said location signal to said cloud database.

16. The method of claim 15 further including adding to (d) the step of adding to said location signal a signal indicative of water delivery parameters.

17. The method of claim 16 wherein said tagging step further includes adding a photograph to said location signal.

18. The method of claim 15 wherein said water delivery parameters include the flow rate of the fire hydrant.

19. The method of claim 18 wherein said tagging step further includes the step of adding descriptive text to said location signal.
